(19) United States
(12) Patent Application Publication
(10) Pub. No.: US 2006/0096909 A1
(43) Pub. Date: May 11, 2006

(54) Conductive plastic fuel filter funnel having improved flow rate and separation

(76) Inventor: Roger Patch, Chugiak, AK (US)

Correspondence Address: LAW OFFICE OF SANFORD J ASMAN, 570 VININGTON CT, ATLANTA, GA, 30350-5710, US

(21) Appl. No.: 10/984,154

(22) Filed: Nov. 9, 2004

(51) Int. Cl. B01D 24/38

(52) U.S. Cl. 210/466; 210/299; 210/303; 210/467; 210/483

(57) ABSTRACT

The fuel filter funnel is made of a conductive plastic. It has an upper portion which includes a round plastic base having a pair of openings into which a pair filters are press fit. The filters have Teflon coated, stainless steel mesh, which is housed in plastic skeletal structures. Having multiple filters permits a flow rate of at least 15 gallons per minute. In operation, the plastic base creates a false floor, which helps in fuel flow, while the lower, cylindrical portion of the filter housing, combined with the lip formed around the openings in the plastic base form a “sump” into which water and impurities in the fuel are directed. The lack of pressurization, combined with the non-stick Teflon coating, prevents contaminants from being forced into the filter media, while the plastic parts of the remaining portions prevent contaminants from sticking, as well, thereby making for a unit which requires neither cleaning nor replacement parts. The spout at the bottom of the funnel is shaped and sized so that standard PVC pipe can be fitted to the funnel in order to direct the flow of clean fuel, as desired.

### BACKGROUND OF THE INVENTION

The present invention relates to a fuel filter funnel. In particular, the invention relates to an improved fuel filter funnel which has been adapted for use with a variety of fuels, has a high flow rate, is able to separate dirt and water from fuel, and which has been adapted for a variety of applications.

Fuel filter funnels are used to fill fuel tanks, such as those on motor vehicles while, at the same time, removing any contaminants from the fuel. In particular, such filter funnels are used to separate water and/or dirt from fuels such as gasoline, diesel fuel, and kerosene.

In the past there were a number of problems with gravity operated (e.g., “passive”) fuel filter funnels. In particular, the fuel filter funnels of the prior art, such as the one described in U.S. Pat. No. 4,430,222 entitled WATER SHEDDING DEVICE which issued on Feb. 7, 1984 to R. E. Walker, were limited as to the rate of fuel flow of which they provided, their ability to separate water from the fuel, and in their ability to deal with issues of static electricity build up. In addition, due to the location of fuel tank filler openings in a variety of vehicles, generators, and other equipment which uses fuel, there were problems with the known fuel filler funnels of the prior art. Attempts to modify the previously known fuel filter funnels, particularly by increasing their size in an attempt to increase their flow rate, resulted in a breakdown of their ability to separate water from fuel.

Another known problem of the fuel filter funnels of the prior art is that fuel is commonly carried in portable containers for use with off-road vehicles and for use by automobile racing teams. Home owners often use portable fuel containers to hold fuel for household devices such as lawn mowers, snow blowers, and for gardening and landscaping equipment. A problem with fueling equipment or vehicles with a volatile, flammable fuel, such as gasoline, is that gasoline vapors are highly flammable, and they are subject to exploding. When gasoline vapors mix with air, an extremely volatile mixture is formed. A spark can ignite this mixture, resulting in an explosive reaction and a fire. It is, therefore, desirable to have a fuel filter funnel which is conductive in order to prevent static buildup, which could lead to an explosion, should there be a spark in the highly flammable fuel-air mixture.

The various problems with the fuel filter funnels previously known, including low fuel flow rate, inability to separate water and dirt from a variety of fuels, e.g., gasoline or kerosene, difficulty in (and the need for) cleaning (or replacing) the filter media, difficulty in using the fuel filter funnel with a variety of vehicles and equipment whose filler openings are arranged behind doors, or oriented in a variety of ways, along with other problems, has not been met by the fuel filter funnels of the prior art. Accordingly, a new design, which solves the foregoing problems has been desired.

### SUMMARY OF THE INVENTION

The present invention is a conductive plastic fuel filter funnel which is capable of handling relatively large fuel flow rates, while, at the same time filtering water and dirt from fuels, such as gasoline and kerosene. The container of the present invention is made of an electrically conductive plastic, and it includes highly effective filter means which prevent water or dirt from passing, while allowing relatively high fuel flow, with ease of cleaning. Further, the fuel filter funnel of the present invention has an outlet tube which has been adapted to allow it to be connected to standard, readily available PVC pipe and elbows, whereby it is easy to use the fuel filter funnel of the present invention with a variety of fuel filler openings in diverse types of vehicles and equipment.

### BRIEF DESCRIPTION OF THE DRAWING

In the drawing:

FIG. 1 is a cross-sectional side view of the fuel filter funnel of the preferred embodiment of the present invention;

FIG. 2 is perspective view of the fuel filter funnel of the present invention;

FIG. 3 is a perspective view of the base which fits into the fuel filter funnel and into which the filters are press-fit;

FIG. 4 is an exploded perspective view of the preferred embodiment of the fuel filter funnel of the present invention;

FIG. 5 is a perspective side view of the filters of the preferred embodiment of the present invention illustrating their construction; and

FIG. 6 is a side view of various configurations of the fuel filter funnel connected to standard PVC pipes.

### DETAILED DESCRIPTION OF EXEMPLARY EMBODIMENTS

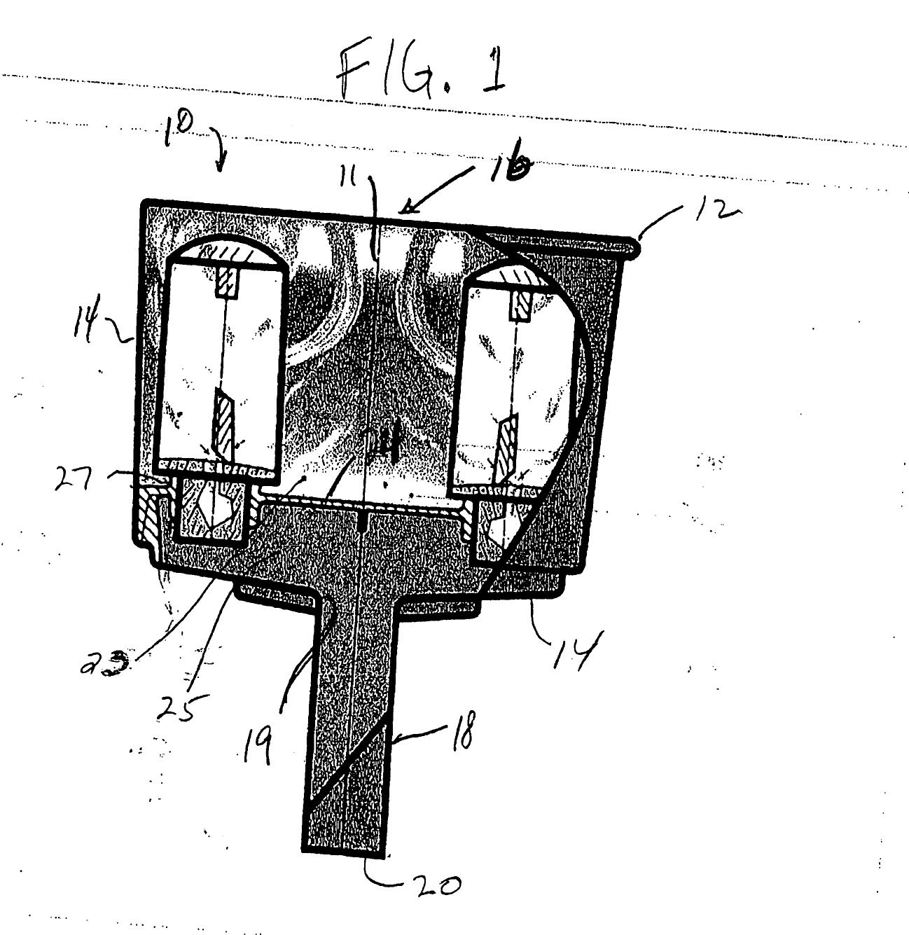

Referring first to FIGS. 1-4, in the preferred embodiment of the invention, the fuel filter funnel 10 includes a substantially cylindrical upper bowl 11 which slopes inward somewhat from the top 12 to the base 14. The upper bowl has a relatively wide opening 16, which is approximately 8 inches in diameter in the preferred embodiment of the invention. The spout 18, which is about 4 inches in length in the preferred embodiment 10, and which has a diameter of about 1⅜ inches at its lower end 20 communicates with the upper bowl through a relatively smaller opening 19 formed through the floor of the upper bowl. The fuel filter funnel 10 is preferably made of an electro-conductive polypropylene plastic which allows the funnel 10 to be grounded or bonded to fuel source, to eliminate static discharges which could lead to explosions.

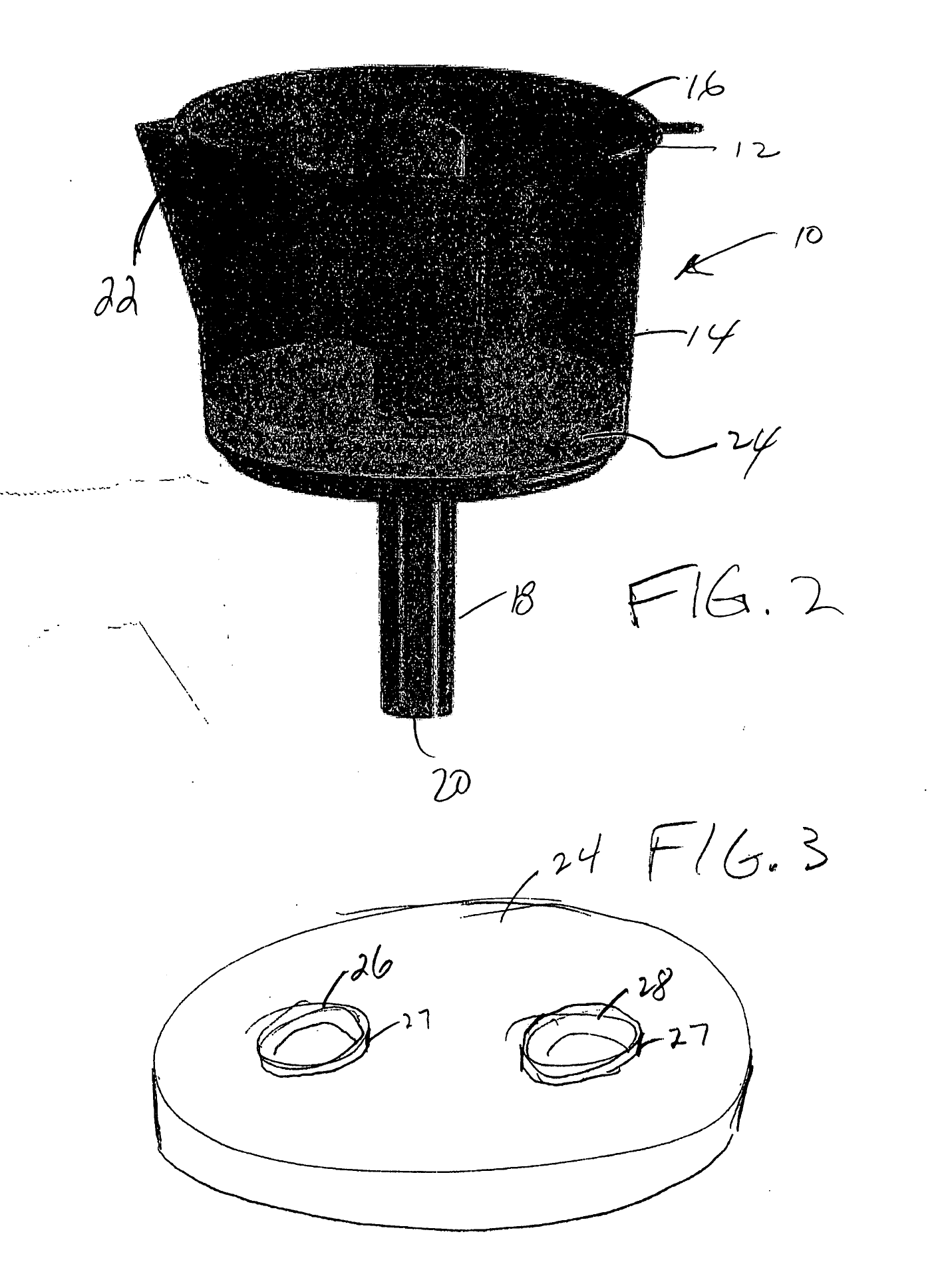

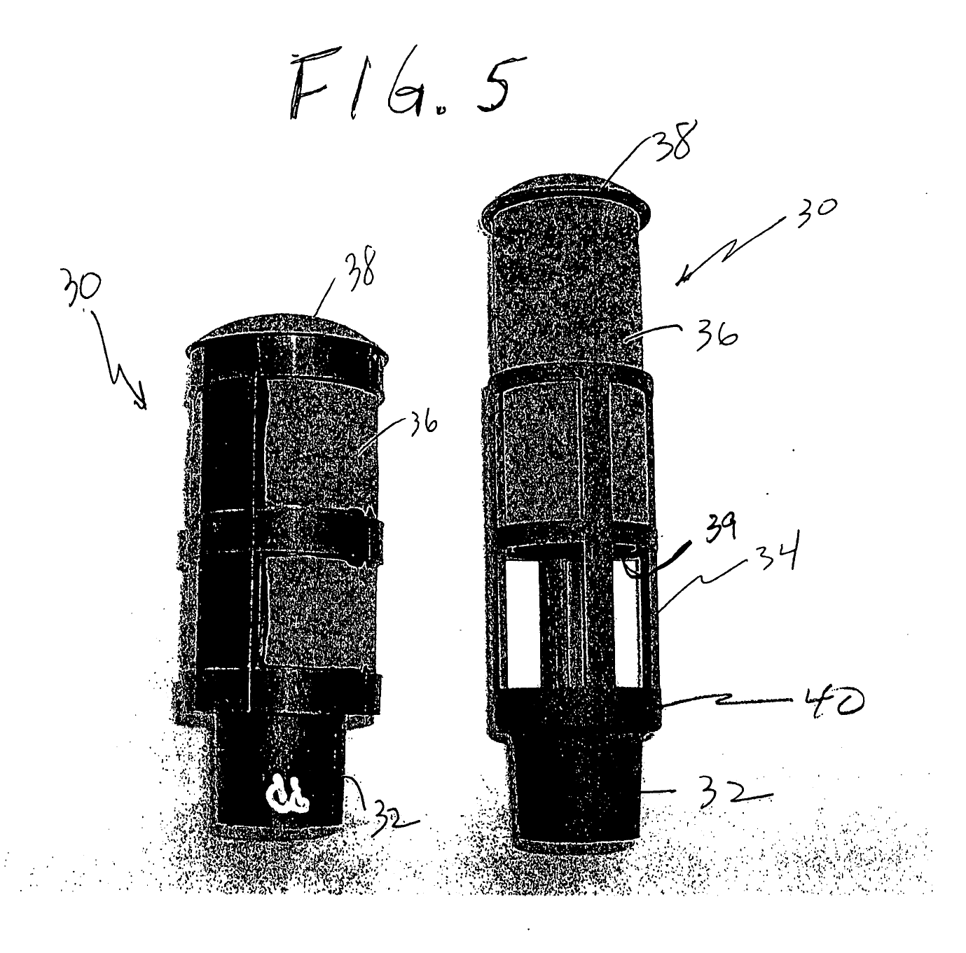

As shown in FIGS. 2 and 4, the fuel filter funnel 10 preferably includes a pouring spout 22 formed in its upper portion, the purpose of which is to allow water, dirt, and other contaminants to be readily poured out of the fuel filter funnel 10, and into a suitable receptacle, for inspection purposes and to allow for proper disposal.

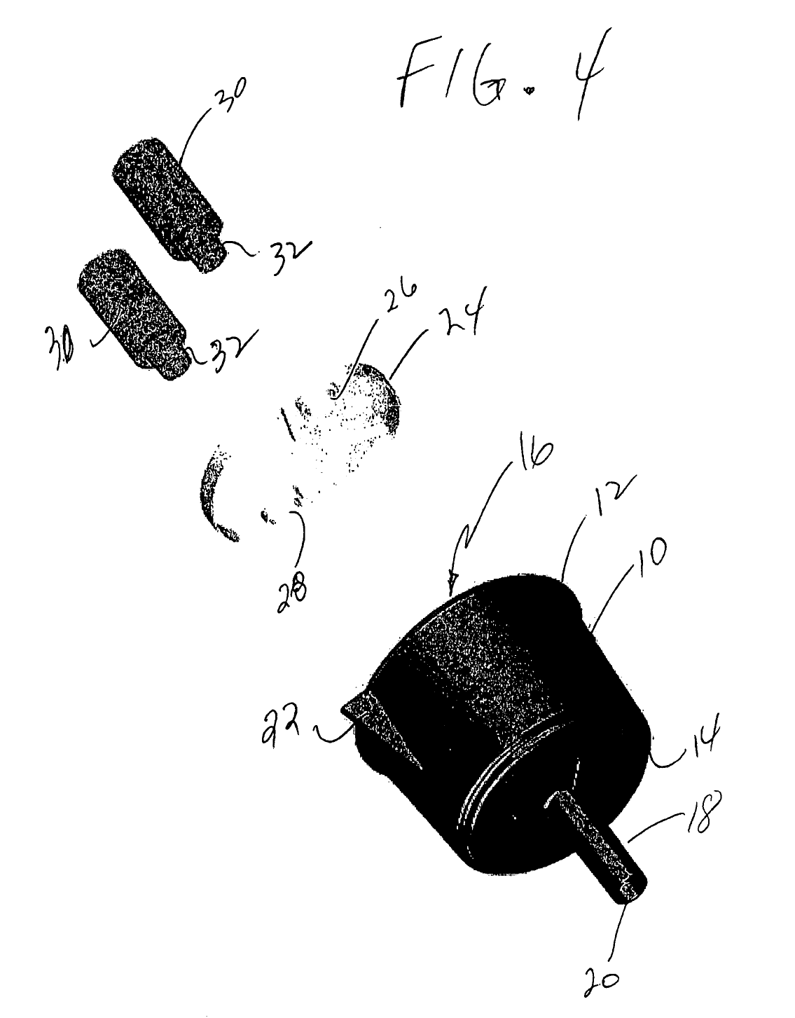

A circular plastic base 24 is fitted into the bottom of the upper bowl 11 of the fuel filter funnel 10, where it creates a “false floor” between an upper portion 23 and a lower portion 25 of the upper bowl 11. The base 24 includes a pair of openings 26, 28, which are round in the preferred embodiment, and which have upwardly, and downwardly extending cylindrical lips 27 (See FIGS. 1 and 3), which help to form a sump in the upper portion 23 of the upper bowl 11. A pair of filters 30 each have lower cylindrical spout portions 32 which are adapted to be press-fit into the openings 26, 28 in the base 24, whereby the filters 30 stand upright in the upper portion 23 of the upper bowl 11 of the fuel filter funnel 10, with their cylindrical spout portions 32 extending down through the base 24, as shown in FIGS. 1 and 2.

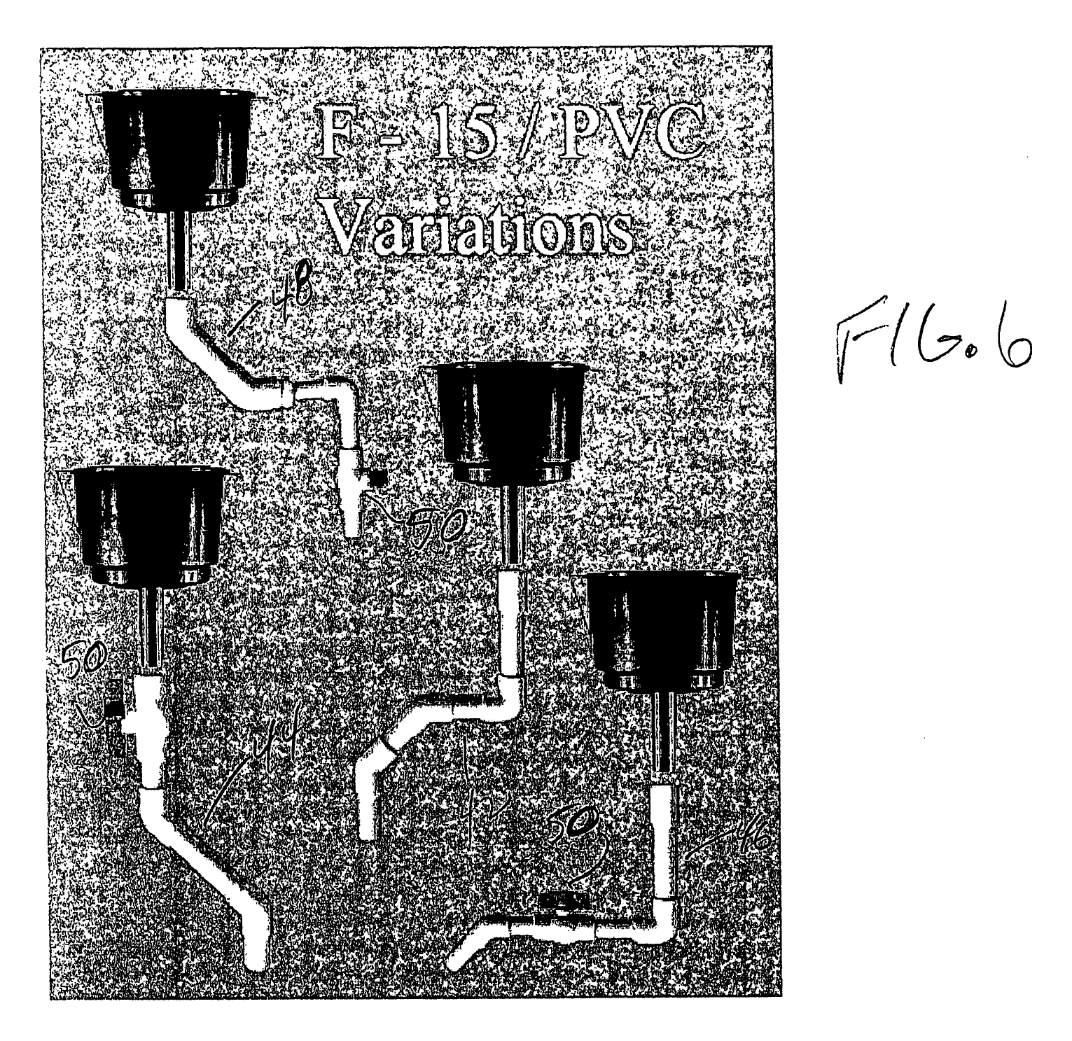

As shown in FIG. 5, the filters 30 each have an outer plastic skeletal structure 34, the lower portion of which comprises the cylindrical spout portion 32. Immediately above the lower cylindrical spout portion 32 is a somewhat wider cylindrical portion 40, which is the bottom of the outer skeleton. Together with the upwardly extending portions of the cylindrical lips 27, the cylindrical portions 40 create a sump above the base 24, and below the filter media 36. In the preferred embodiment, the filter media 36 is comprised of a Teflon coated stainless steel mesh which performs the fuel/water and fuel/impurity separation. The filter media 36 is quite thin, so it is preferably formed as a cylinder around an inner plastic form (not shown) which has a somewhat domed upper portion 38 and a cylindrical lower portion 39. In the preferred embodiment of the invention the screens 36 are preferably made of 200 mesh (200 wires per inch) Teflon coated stainless steel wire having a 74 micron rating, and they preferably have a wire diameter of 0.0023 inches with an opening width of 0.0027 inches, which is available as a wire cloth product from Gerard Daniel, 34 Barnhart Drive, Hanover, Pa. 17331.

While the foregoing wire mesh filter media 36 has been found to provide superior water separation and filtration, as compared to the media heretofore known and used in the fuel filter funnel described in U.S. Pat. No. 4,430,222 described above (which used a 100 mesh media), it was found that the 200 mesh media used in the preferred embodiment of the present invention could not be incorporated into a filter having a polypropylene frame in the same manner as the 100 mesh media of the prior att. In the filters of the prior art (which used 100 mesh media) it was possible to place the media into the injection mold, then inject hot plastic, which penetrated and fused with the filter media to form the prior art filter. It was found that the hot, molten polypropylene would not penetrate the 200 mesh media used in the present invention. Accordingly, it was necessary to devise a new manufacturing process in order to manufacture the filters 30. In particular, in order to manufacture a filter 30 of the present invention, one first manufactures the internal frame (not illustrated), which has the same appearance as the external frame 34 shown in FIG. 5, but which includes the upper dome portion 38, but which does not include the spout 32. In particular, the internal frame of the preferred embodiment has upper, lower, and middle plastic rings which are spaced apart and held together by four vertical members in the same manner and configuration as the external frame 34. Next, the media 36 is wrapped around the internal frame, and its ends are glued together where they overlap over one of the vertical members of the internal frame. The external frame 34 is injection molded separately from the internal frame, and the internal frame with the media 36 attached, is inserted into the external frame 34, and their respective vertical members are aligned. The assemblage of the internal and external frames, with the media therebetween, is then subjected to a bonding process, which may be accomplished either by heating in an oven or by a sonic welding process to bond the upper and lower portions of the internal and external frames, thereby completing the manufacture of the filter 30.

It has been found that the foregoing screen material, which comprises the filter media 36, maximizes the removal of water from fuel when the spout 32 of a filter 30 has an opening which is approximately one inch in diameter. Efforts to increase the flow rate by increasing the diameter of the spout 32 of a filter 30 has been found to cause too great a suction, which results in the failure of the filter 30 to remove all of the water in contaminated fuel. Accordingly, it has been found that in order to increase the flow rate of the fuel filter funnel 10, it is necessary to provide a plurality of filters 30 in order to insure that the spout diameter of each filter 30 is no more than one inch.

The combination of the two filters 30, the small diameter stainless steel wire, and selected mesh provide the passive fuel filter funnel 10 of the present invention with the ability to provide a flow rate of 15 gallons per minute, which is greater than normal gasoline pumps can legally pump fuel (which is limited to 10 gallons per minute), although there are fuel pumps at “truck stops” and marinas which are capable of higher fuel flow rates which could be addressed by increasing the number of filters 30.

In the past, efforts to increase the flow rate of the passive fuel filter funnels of the prior art so as to provide a fuel filter funnel capable of being used in commercial facilities were unsuccessful, as efforts to increase the size of the filters led to making taller (or wider) filters, with the result being that the increased pressure created a flow rate which was too high, which (in turn) caused a low pressure area to suck water through the filter media screens. Thus, taller funnels created too much head pressure and failed to provide water separation. Accordingly, an important feature of the present invention is the presence of a plurality of filters which are not too tall when flow rates higher than about 7.5 gallons per minute are desired. In the preferred embodiment of the invention, the tops 38 of the filters 30 are less than about 4 inches from the plastic base 24, the diameter of the upper portion of each filter 30 is about two inches, and the lower spout portion 32 has an opening with a diameter of approximately one inch.

In use, the cylindrical lower spout portions 32 of the filters 30 are pressed into the openings in the plastic base 24 which is fitted into the upper portion of the fuel filter funnel 10.

As indicated above, an important feature of the present invention is that a “sump” is created above the false floor in the lower portion of the upper bowl 11 of the funnel 10. below the screens 36. The sump area is defined by the cylindrical lips 27 formed around the openings 26, 28 in the plastic base 24, and the cylindrical lower portions 40 of the filters 30. It has been found that impurities collect in the sump, and that the sump is needed in order to cause proper fuel/water separation to begin. Accordingly, the sump is a required part of the present invention which cannot be eliminated. Once the separation of water begins it does not matter how much water is mixed with the fuel, as the funnel 10 always provides almost 100% water separation. In the preferred embodiment of the invention, the sump extends about three-quarters of an inch above the plastic base 24.

In use, when fuel is poured into the upper bowl 11 of the fuel filter funnel 10 the screens 36 of the filters 30 perform a separation which permits only clean, filtered fuel, without water or impurities, to flow through them, down through the false floor, and into the area beneath the plastic base 24, from which it then flows out the opening 20 in the spout 18.

The false floor beneath the plastic base 24 allows faster fuel flow by eliminating restrictions, while the two filters 30 placed, as shown, provide maximum fuel flow without over pressurizing the filters 30.

As nothing sticks to the plastic from which the fuel filter funnel 10, and all of its components, other than the filter media 36, are formed, and as the filter media is Teflon coated, so nothing sticks to it, either. Since this is a passive (e.g., gravity operated) vertical filter, as opposed to a pressurized conventional, horizontal fuel filter of the type often used in vehicular fuel lines, fuel is not forced through the filter media 36 under pressure. Instead, gravity creates the head pressure based on the vertical “head” of fuel present in the bowl 11, so the only thing the filter media 36 must do is to deflect any water and/or other contaminants, which then fall into the sump formed at the bottom of the bowl 11 which occurs because water and the other contaminants are heavier than the fuel being filtered. Since it would take pressure to force contamination into the openings in the filter media 36, and since no such pressure is present in the fuel filter funnel 10 of the present invention, neither water, nor other contaminants are forced into the mesh of the media 36, so the media does not become contaminated, eliminating any need to clean or replace the media 36.

Another benefit of the fuel filter funnel 10 of the present invention is illustrated with reference to FIG. 6, in which a variety of output configurations, each of which is made of standard PVC pipe, connectors, and elbows, are shown, a number of which also include valves 48. As used herein the expression “standard PVC” is meant to refer to the various PVC pipes, connectors, valves, and other components which are available at home centers, such as Home Depot or Lowes, as well as at plumbing supply houses. The spout 18 of the preferred embodiment of the funnel 10 was intentionally designed to facilitate its connection to standard 1″ PVC pipe, as shown in FIG. 6.

I claim:

1. A fuel filter funnel comprising:
(a) an upper bowl, said upper bowl having a large opening for receiving fuel and a floor with a relatively smaller opening formed therethrough;
(b) a funnel spout connected to said smaller opening formed in said floor of said upper bowl;
(c) means for forming a false floor within said upper bowl, said means for forming a false floor separating said upper bowl into an upper portion and a lower portion, said floor of said upper bowl being below said means for forming a false floor;
(d) at least one filter having a filter media comprised of wire mesh, said filter having a structure and shape which holds said filter media around a form which creates an internal cavity in said filter, said internal cavity having an opening formed at the lowermost portion thereof, said at least one filter including a spout which is adapted to sealably connect said cavity to an opening formed in said means for forming a false floor, whereby fuel which flows through said filter media will pass into said cavity, through said spout, and through said means for forming a false floor; and
(e) sump forming means which vertically separates the lower portion of said filter media from said means for forming a false floor, whereby impurities in said fuel can collect in the sump formed in said upper portion of said upper bowl between said means for forming a false floor and said lower portion of said filter media.

2. The fuel filter funnel of claim 1 wherein said at least one filter is formed as a cylinder with an internal skeletal frame which supports said filter media from within, said cavity being formed within said internal skeletal frame.

3. The fuel filter funnel of claim 2 wherein said at least one filter further comprises an external frame which, together with said internal skeletal frame, sandwiches said filter media therebetween.

4. The fuel filter funnel of claim 3 wherein said external frame has an upper section and a lower section, said upper section holding said filter media, and said lower section including said spout.

5. The fuel filter funnel of claim 4 wherein said filter media is comprised of Teflon coated stainless steel mesh.

6. The fuel filter funnel of claim 5 wherein said spout is cylindrical, and the diameter of said spout is no more than 1 inch.

7. The fuel filter funnel of claim 6 wherein the upper section of said at least one filter has a diameter of approximately 2 inches.

8. The fuel filter funnel of claim 3 wherein said sump forming means comprises a portion of said external frame, said portion extending below said filter media.

9. The fuel filter funnel of claim 1 wherein said upper bowl is substantially cylindrical.

10. The fuel filter funnel of claim 9 wherein said sump forming means comprises a lip formed around, and extending upward from, said means for forming a false floor.

11. The fuel filter funnel of claim 3 wherein said sump forming means comprises a lip formed around, and extending upward from, said means for forming a false floor.

12. The fuel filter funnel of claim 9 wherein aid upper bowl has a diameter of approximately 8 inches.

13. The fuel filter funnel of claim 1 wherein said upper bowl further comprises a pouring spout, whereby impurities retained in said sump can be poured out of said upper bowl through said spout and into a container, whereby inspection of any contaminants will be facilitated.

14. The fuel filter funnel of claim 1 wherein all of said parts, other than said filter media, are formed from a conductive plastic.

15. The fuel filter funnel of claim 14 wherein said conductive plastic is a polypropylene.

16. The fuel filter funnel of claim 1 wherein said funnel spout is formed with an outside diameter selected to fit standard PVC pipe of the type used for plumbing applications.

17. The fuel filter funnel of claim 1 further comprising a plurality of filters whereby the flow rate can be increased, as desired without increasing the diameter of the spout of any of said filters to more than one inch.

18. A filter comprising:
(a) an internal frame having at least two spaced apart rings held together and separated from one another by at least two vertical members;
(b) a wire mesh filter media which is wrapped around said vertical members of said internal frame, the ends of said media being attached to each other;
(c) an external frame which surrounds and retains said internal frame with said wire mesh filter media being retained between said internal frame and said external frame

19. The filter of claim 18, wherein said frames are made of injection molded polypropylene.

20. The filter of claim 19 wherein said wire mesh filter media is made of Teflon coated stainless steel.

21. The filter of claim 20 wherein said filter media is comprised of 200 mesh media.

22. The filter of claim 19 wherein said filter media has a substantially 74 micron rating.

23. The filter of claim 18 wherein said internal frame has a domed upper portion.

24. The filter of claim 18 wherein said external frame has a spout.

25. The filter of claim 24 wherein said internal frame has a domed upper portion.

26. The filter of claim 25 wherein said internal frame and said external frame are each comprised of three rings, the same being an upper ring, a lower ring, and a middle ring.

27. The filter of claim 26 wherein said internal frame and said external frame are each comprised of four substantially equally spaced vertical members.

28. The method of manufacturing a filter of the type comprising a wire mesh screen, said method comprising the steps of:
(a) forming an internal frame having vertical members which are spaced around a central opening, said spacing being provided by a plurality of spacing members;
(b) wrapping a wire mesh media around said vertical members and bonding the ends of said media together;
(c) forming an external frame which has substantially the same configuration as said internal frame;
(d) inserting said internal frame, with said media affixed thereto, into said external frame; and
(e) bonding said internal frame to said external frame.
